(19) United States
(12) Patent Application Publication
(10) Pub. No.: US 2008/0039573 A1
(43) Pub. Date: Feb. 14, 2008

(54) Polymers of macrocyclic oligomers containing highly expanded graphite

(75) Inventors: Robert C. Cieslinski, Midland, MI (US); David H. Bank, Midland, MI (US); Parvinder Singh Walia, Midland, MI (US)

Correspondence Address: The Dow Chemical Company;Gary C. Cohn, 1147 North 4th Street, Unit 6E, Philadelphia, PA, 19123, US

(73) Assignee: Dow Global Technologies, Inc.

(21) Appl. No.: 11/891,259

(22) Filed: Aug. 9, 2007

Related U.S. Application Data
(60) Provisional application No. 60/836,809, filed on Aug. 10, 2006.

(51) Int. Cl. C08K 3/04

(52) U.S. Cl. 524/495; 516/77

(57) ABSTRACT

Composites of a macrocyclic oligomer and expanded graphite particles are prepared. The expanded graphite particles are easily incorporated into the composite at useful levels to provide desirable properties such as good heat distortion temperatures, good heat resistance, and sufficient electroconductivity to make the composite suitable for painting in electrostatic coating processes. The expanded graphite is characterized in having a very low bulk density and high surface area.

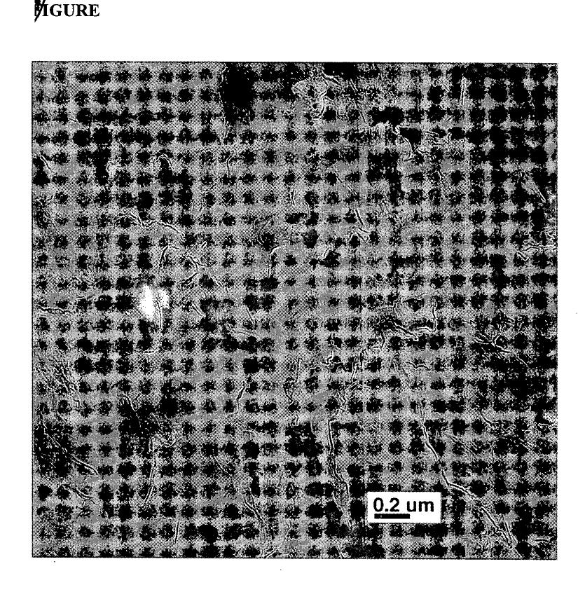

### CROSS-REFERENCE TO RELATED APPLICATION

This application claims benefit of U.S. Provisional Patent Application 60/836,809, filed 10 Aug. 2006.

### BACKGROUND OF THE INVENTION

The invention relates to polymers derived from macrocyclic oligomers containing expanded graphite as a filler.

Macrocyclic oligomers have been developed which form polymeric compositions with desirable properties such as strength, toughness, high gloss and solvent resistance. Among preferred macrocyclic oligomers are macrocyclic polyester oligomers such as those disclosed in U.S. Pat. No. 5,498,651, incorporated herein by reference. Such macrocyclic polyester oligomers are excellent starting materials for producing polymer composites because they exhibit low melt viscosities, which facilitate good impregnation and wet out in composite applications. Furthermore, such macrocyclic oligomers are easy to process using conventional processing techniques.

Many potential applications for these polymerized macrocyclic oligomers require the polymer to withstand elevated temperatures. An example of such an application is an automotive body part. These parts are usually painted in a so-called electro-deposition, or “E-coat” process. This process applies a coating to an automotive assembly for corrosion protection via galvanic water-solution immersion. To be usable in this process, the polymer must be somewhat conductive, so a charge can be applied to it during the galvanic coating step. Once the coating has been applied, it is then dried at temperatures up to 205° C. to remove moisture and to cure the coating. The temperature associated with this process is high enough that most plastics are unable to pass through it without deformation due to creep of as a result of the combined effects of stress and temperature. Unless modified in some way, polymerized macrocyclic oligomers are usually not suitable for use in an e-coat process. This means that they must be coated in a separate operation and then assembled onto the vehicle frame. The extra costs required to do this make the use of these polymers uncompetitive for these applications.

Polymers of macrocyclic oligomers have been compounded with layered clay materials to improve their thermal properties. Heat distortion temperature under load (DTUL) is a useful measure of these properties. Polymerized macrocyclic oligomers that are filled with layered clays can in some cases achieve DTUL values that are in the range of 170° C. or somewhat higher.

These clays have proven difficult to disperse into the macrocyclic oligomer. In order to overcome this problem, certain organic-modified clays have been developed. The organic modification is introduced by treating the clay with an onium compound (typically a quaternary amine). Methods for doing this are described, for example, in U.S. Pat. Nos. 5,530,052 and 5,707,439, and WO 04/058868. The organic modification facilitates the exfoliation of the layered clays, which results in a finer dispersion of the clay and more efficient property enhancement.

The organic modifiers tend to be thermally unstable at the temperatures at which the macrocyclic oligomers are polymerized. Organic materials (either the modifier itself or some degradation or reaction product thereof) are believed to be released from the modified clay. These organic materials are believed in some cases to cause some deterioration of the physical properties of the polymer/clay composite. The exact mechanism or mechanisms for this deterioration are not well understood, but may include partial deactivation of the polymerization catalyst, catalysis of a depolymerization reaction, or other mechanisms. These problems limit the applicability of layered clays as fillers in these systems.

Even when good mechanical properties are obtained with a clay-filler polymer, the dispersed clays provide little electroconductivity to the polymer. Other measures must be employed to impart enough electroconductivity to the polymer to use it in an e-coat process or other processes requiring some electroconductivity. These other measures add to the cost of the polymer

It is also important that the filled polymer exhibit adequate physical properties for its particular application. In particular, the polymer should exhibit adequate tensile, elongation, impact and dynamic mechanical properties for the chosen application.

Thus, it is desirable to prepare a polymer of a macrocyclic oligomer, which has an adequate heat deflection temperature for many applications and which is sufficiently conductive to be coated in E-coat process. The polymer should have good physical properties, suitable for the applications of choice and should be capable of being prepared simply, conveniently and inexpensively.

### SUMMARY OF THE INVENTION

In one aspect, this invention is a composite comprising a matrix of a polymer of a macrocyclic oligomer, the polymer matrix having dispersed therein at least about 1% by weight of expanded graphite particles, based on the weight of the composite.

In a second aspect, this invention is a dispersion of expanded graphite particles in a macrocyclic oligomer, the dispersion containing at least about 1% by weight of the expanded graphite particles.

In another aspect, this invention is a polymerization process comprising subjecting a dispersion of expanded graphite particles in a macrocyclic oligomer to conditions sufficient to polymerize the macrocyclic oligomer to form a composite comprising a matrix of a polymer of a macrocyclic oligomer, the polymer matrix having dispersed therein at least about 1% by weight of expanded graphite particles.

In another aspect, this invention is polymerization process comprising:

a) polymerizing a dispersion of expanded graphite particles in a macrocyclic oligomer to form a filled polymer of the macrocyclic oligomer, the polymer having dispersed therein at least about 1% by weight of expanded graphite particles having a BET surface area of at least 15 m²/g and a volume of at least 100 cc/g;

b) cooling the formed filled polymer to below the softening temperature of the filled polymer and then

c) advancing the molecular weight of the polymer of the macrocyclic oligomer by heating the formed composite to an elevated temperature below the softening temperature of the filled polymer.

Composites according to the invention exhibit good thermal properties, in particular a good heat distortion temperature under load. The composites exhibit good physical properties, such as tensile, elongation and impact properties that make the composites useful in a range of applications. The composites typically exhibit a high storage modulus at a range of temperatures from 0° C. to 160° C. or more. The good physical properties are indicative of efficient use of the expanded graphite filler particles.

The expanded graphite particles efficiently reduce the volume resistivity of the composite. The composites of the invention frequently exhibit volume resistivities of 1×10⁶ ohm-cm or less and in many cases well below that value, depending to some extent on the loading of the expanded graphite and certain characteristics (in particular, the surface area) of the expanded graphite. These volume resistivities are often obtained at expanded graphite levels in the range of 2-6% or so by weight of the composite, which again indicates the efficiency of the expanded graphite particles in imparting electroconductive properties to the composite. This combination of properties makes the composites of the invention useful in a wide variety of structural applications. Applications of particular interest include various types of vehicular parts, such as vehicular body panels, which are generally E-coated during the automobile production process.

### BRIEF DESCRIPTION OF THE DRAWING

The FIGURE is a transmission electron micrograph of an embodiment of a composite of the invention.

### DETAILED DESCRIPTION OF THE INVENTION

The macrocyclic oligomer used in this invention is a polymerizable cyclic material having two or more ester linkages in a ring structure. The ring structure containing the ester linkages includes at least 8 atoms that are bonded together to form the ring. The oligomer includes two or more structural repeat units that are connected through the ester linkages. The structural repeat units may be the same or different. The number of repeat units in the oligomer suitably ranges from about 2 to about 8. Commonly, the cyclic oligomer will include a mixture of materials having varying numbers of repeat units. A preferred class of cyclic oligomers is represented by the structure
—[O-A-O—C(O)—B—C(O)]_{y}— (I)
where A is a divalent alkyl, divalent cycloalkyl or divalent mono- or polyoxyalkylene group having two or more carbon atoms, B is a divalent aromatic or divalent alicyclic group, and y is a number from 2 to 8. The bonds indicated at the ends of structure I connect to form a ring. The macrocyclic oligomer desirably is a solid at room temperature (˜22° C.) and more preferably has a melting temperature in excess of 100° C. Examples of suitable macrocyclic oligomers corresponding to structure I include oligomers of 1,4-butylene terephthalate, 1,3-propylene terephthalate, 1,4-cyclohexenedimethylene terephthalate, ethylene terephthalate, and 1,2-ethylene-2,6-naphthalenedicarboxylate, and copolyester oligomers formed from two or more of these. The macrocyclic oligomer is preferably one having a melting temperature of below about 200° C. and preferably in the range of about 150-190° C. A particularly preferred cyclic oligomer is an oligomer of 1,4-butylene terephthalate.

Suitable methods of preparing the cyclic oligomer are described in U.S. Pat. Nos. 5,039,783, 6,369,157 and 6,525,164, WO 02/18476 and WO 03/031059, all incorporated herein by reference. In general, cyclic oligomers are suitably prepared in the reaction of a diol with a diacid, diacid chloride or diester, or by depolymerization of a linear polyester. The method of preparing the cyclic oligomer is generally not critical to this invention.

Graphites can be characterized as layered planes of carbon atoms. Within the planes, the carbon atoms form connected hexagonal structures. Adjacent planes are bonded through weak van der Wals forces. The graphitic structure is often characterized as having the planes aligned along a pair of orthogonal a axes, and a c axis that is perpendicular to the planes. The expanded graphite used in the invention is expanded along the so-called c axis, i.e., perpendicular to the planes. This results in an increase in the surface area of the expanded graphite. The expansion process also introduces a significant amount of oxygen into the graphite layers.

The expanded graphite suitably has a BET (Brunauer, Emmett and Teller) surface area of at least 10 m²/g. Preferably, the BET surface area is at least 30 m²/g. More preferably the BET surface area is at least 120 m²/g. An even more preferred expanded graphite has a BET surface area of at least 250 m²/g. A still more preferred expanded graphite has a BET surface area of at least 400 m²/g. An especially preferred expanded graphite has a BET surface area of at least 650 m²/g. The upper limit on the BET surface area may be in principle up to about 2700 m²/g, which is the approximate theoretical surface area of fully expanded graphite. However, expanded graphite having a surface area up to about 1500 m²/g or even up to about 1000 m²/g is suitable. For purposes of this invention, the BET surface area measurement can be made using 30% nitrogen in helium, at a P/P₀ ratio of 0.3. A variety of commercially available devices are useful for measuring BET surface area including a Micromeritics TRISTAR 3000 device and a Quantachrome Monosorb tester. Samples are suitably outgassed prior to making the measurements, with suitable conditions being 200° C. at atmospheric pressure. An average of multiple data points can be used to determine the BET value.

The expansion of the graphite tends to increase the volume of the material per unit weight. The expanded graphite is one that has been expanded to a volume of at least 100 cc/g. Volumes of at least 200 cc/g are preferred and volumes of at least 300 cc/g are even more preferred. It is recognized, however, that post-expansion treatments such as milling or grinding may have a very significant effect on the volume of the expanded graphite material.

Still another indication of the degree of expansion is provided by wide angle X-ray spectroscopy (WAXS). Unexpanded graphite exhibits an intense crystalline peak at a d-spacing of about 3.36±0.02 Angstroms (about 26.5 degrees 2θ for copper Kα radiation). This peak is associated with the intra-planar spacing of the natural graphite, which is typically on the order of 0.34 nm. The intensity of the peak is an indication of the degree to which this inter-planar spacing is retained. The expansion of the graphite leads to a separation of at least some of the layers. The separation of the layers during the expansion process can lead to a shift of the 3.36±0.02 crystalline peak and a diminution of its intensity. A preferred expanded graphite exhibits no measurable peak at 3.36±0.02 d-spacing that corresponds to the graphite inter-layer spacing. WAXS is conveniently performed for purposes of this invention using a Bruker D-8 or Rigaku MiniFlex diffractometer with a Cu Kα radiation source, although other commercially available diffractometers are also useful.

A preferred expanded graphite has a volume of at least 200 cc/g and a BET surface area of at least 30 m²/g. A more preferred expanded graphite has a volume of at least 100 cc/g, a BET surface area of at least 100 m²/g and no detectable WAXS diffraction peak at 3.36±0.02 d-spacing. An even more preferred expanded graphite has a volume of at least 100 cc/g, a BET surface area of at least 500 M²/g and no detectable WAXS diffraction peak at 3.36±0.02 d-spacing.

Various methods of forming expanded graphite particles are known. Among those methods are those described in U.S. Pat. Nos. 3,404,061, 4,895,713, 5,176,863, 6,406,612 and 6,416,683, U.S. Published Patent Applications 2003-0116753, 2004-0000735, 2004-0033189 and 2004-0034151. These methods generally involve intercalating the graphite with a volatile expanding agent, drying it to remove excess liquids, and then heating the intercalated material to a temperature sufficient to turn the expanding agent into a gas. The expansion of the gas produced in this manner forces the layered planes of the graphite apart, thereby reducing the density and increasing the surface area. Temperatures in the range of 160° C. to about 1100° C. or more can be used, depending on the selection of the expanding agent. A temperature in the range of 600° C. to 1100° C. is generally preferred. The graphite particles are preferably heated very rapidly to the expansion temperature. Heating can be performed in various manners, such as by placing the particles into a heated oven or by applying microwave energy to the particles.

The expanding agent typically includes a mineral acid such as sulfuric acid or nitric acid. Combinations of these may be used. Certain organic acids may be used as expansion aids, as described, for example, in U.S. Pat. No. 6,416,815. Organic reducing agents, in particular aliphatic alcohols, can also be used, also as described in U.S. Pat. No. 6,416,815. The graphite may contain a small quantity of ash. An oxidant such as potassium chlorate, potassium permanganate and/or hydrochloric acid may also be used.

These expanding agents tend to be strong oxidants, and the expanded graphite product tends to be somewhat oxidized. An expanded graphite material having a degree of oxidation is considered to be within the scope of the invention. A graphite that is intercalated with these expanding agents may contain as much as 50% oxygen by weight (of the graphite less intercalating materials). A typical amount of oxygen in the intercalated sample is about 20-40% by weight. During the expansion process, some of this oxygen is lost in the form of water, carbon dioxide and other species, so the expanded graphite more typically contains from about 10 to about 25% by weight oxygen.

The starting graphite material preferably has an average particle size of at least 50, more preferably at least 75 microns. The starting graphite material preferably has an average particle size up to about 1000 microns, more preferably up to 500 microns. Smaller particles tend to expand less due to the loss of expansion agent at their edges. Larger particles are more difficult to intercalate fully with the expansion agent.

Expandable graphite flakes and/or powders are commercially available and can be used as starting materials. Examples of such expandable graphite products are available commercially under the tradenames GRAFGuard® 160-50N (from GRAFTech Inc., Advanced Energy Technologies Division, Parma, Ohio) and HP-50 (from HP Material Solutions, Northridge, Calif.). These can be expanded by heating to the aforementioned temperature ranges. The GRAFGuard 160-50N product is intercalated with nitric and sulfuric acids, and is believed to further contain an organic acid and alkanol reducing agent. The intercalated materials are believed to constitute 20-30% by weight of the expandable graphite product.

An expandable graphite of particular interest is made by intercalating a native graphite or an expandable graphite flake as just described with a mixture of sulfuric and nitric acids, optionally further with potassium chlorate and hydrochloric acid. An expandable graphite which is particularly suitable for this purpose is the GRAFGuard® 160-50 material. An intercalation process as described by Staudenmaier in Ber. Dtsch. Chem. Ges. 1898, 31 p. 1484 is suitable and preferred. The intercalated material is dried and expanded as described before. The ability to form very highly expanded graphite materials appears to be related to the length of time that the graphite is exposed to the intercalating materials. Thus, the formation of expanded graphite products having surface areas of 120 m²/g or more is favored by longer treatment times. This is even more the case when the desired surface area is 250 m²/g or 400 m²/g or more. Treatment times on the order of about 4 hours to 200 hours or more, particularly, 10 hours to 150 hours and especially 20 hours to 120 hours are generally suitable for obtaining these high surface area products. Characteristics of the starting material, such as particle size, purity and whether any pre-treatments have been performed, also affect the degree of expansion that is obtained.

The expanded graphite produced by this process typically assumes a vermiform (worm-like) appearance, with a longest particle size generally in the range of about 0.1 to about 10 millimeters. The expanded graphite particles are often referred to as “worms”. These expanded graphite particles can be used directly without further treatment to reduce particle size. It is also within the scope of the invention to mill the worms to produce smaller particle size particulates.

The composite of the invention can be prepared by forming a blend of the expanded graphite and macrocyclic oligomer, and then polymerizing the macrocyclic oligomer in the presence of the expanded graphite.

The oligomer/expanded graphite blend can be prepared in various ways. For example, a dry blend can be made by simply mixing oligomer particles with expanded graphite particles at the desired ratios. The dry blend can then be subjected to polymerization conditions to form the composite, as described more fully below.

The oligomer/expanded graphite blend can alternatively be prepared by a melt blending process, in which the oligomer is melted and then blended with the expanded graphite particles. The melt blending method can be conducted as a step of a polymerization process by which a composite of the invention is formed. Alternatively, the melt blending can be performed under conditions (notably, the preferred absence of a polymerization catalyst) under which little or no polymerization takes place. Sufficient mixing is performed to wet out the expanded graphite particles. An advantage of the invention is that the macrocyclic oligomer forms a low viscosity melt that can easily wet out and penetrate the expanded graphite particles.

A third method of forming the oligomer/expanded graphite blend is through a solution method, in which the macrocyclic oligomer is dissolved in a suitable solvent. The oligomer may be dissolved in the solvent before the expanded graphite is added. Alternatively, the oligomer and expanded graphite may be dry blended as described before, followed by adding the solvent and heating (if necessary) to dissolve the oligomer. It is also possible to first form a slurry of the expanded graphite in the solvent, followed by adding the oligomer (which may be added as a melt or a pre-formed solution in an additional quantity of the solvent). An advantage of the solution method is that lower temperatures can be used and so the risk of premature polymerization and thermal degradation of the oligomer is reduced. Because lower temperatures can be used, this process permits the blend to be formed in the presence of the polymerization catalyst. The solvent is preferably removed from the resultant blend before it is polymerized to form a composite of the invention. However, it is possible to perform the polymerization in the presence of the solvent.

Suitable solvents include materials that are liquid at room temperature or some mildly elevated temperature (such as up to 50° C.), which are solvents for the macrocyclic oligomer at some temperature below the boiling temperature of the solvent, and which do not undesirably react with the expanded graphite or the macrocyclic oligomer. The solvent may be relatively high-boiling, for example, one having a boiling temperature of about 100 to about 300° C., especially from about 100 to about 200° C. However, lower-boiling solvents having a boiling temperature of below 100° C. are preferred, as this makes it easier to remove the solvent from the oligomer/expanded graphite blend. Suitable solvents include halogenated (especially chlorinated) hydrocarbons such as methylene chloride, chloroform, orthodichlorobenzene, aromatic and/or alkyl-substituted aromatic hydrocarbons, and high boiling ethers, ketones, alcohols and esters.

The amount of solvent can vary significantly. A suitable concentration of solvent is from about 1 to 95% of the combined weight of the solvent, macrocyclic oligomers, and any optional co-monomers, crosslinkers and modifiers that may be present. A more suitable concentration thereof is about 10-80% by weight. An especially suitable concentration is about 25-75% by weight.

If desired, energy can be applied to any of the blends (while the oligomer is molten or dissolved in a solvent) to help disperse the expanded graphite particles into the oligomer. This energy can be supplied mechanically through the application of shear. A preferred way is to apply ultrasonic energy to the blend.

Raw materials (filler particles, diluent, macrocyclic oligomer and other optional components) that contain water or volatile impurities are preferably dried prior to forming the oligomer/expanded graphite blend.

In any of the foregoing methods, the oligomer and expanded graphite may be combined in the same proportions as will be present in the composite after the oligomer is polymerized. An alternative approach is to form a masterbatch in which the expanded graphite is more highly concentrated. The masterbatch is then let down with additional oligomer (and/or other polymers or polymerizable materials) when the composite is made. A masterbatch is conveniently prepared using the same methods just described, although the expanded graphite concentration is typically somewhat higher. The masterbatch may contain up to 65% or more dispersed expanded graphite particles, for example, from 5 to 60% by weight of the expanded graphite, from 10 to 50% or from 10 to 30% by weight of the expanded graphite. The balance of the masterbatch is made up of oligomer and optional materials as described more below.

The oligomer/expanded graphite blend may include one or more other components, such as a polymerization catalyst, comonomer, chain extender, another polymer, an impact modifier or a rubber, all as described more below. These may be added into the blend during its initial formation as described above, or separately added to the pre-formed blend. It is within the scope of the invention to include one or more additional fillers in the blend.

The oligomer/expanded graphite blend is in most instances a solid material at room temperature, because of the high melting temperature of the macrocyclic oligomer. The blend may be ground or pelletized to facilitate its use in a subsequent polymerization process.

A composite is formed by polymerizing the macrocyclic oligomer (and other polymerizable materials, if any) in the presence of the expanded graphite. Methods of polymerizing cyclic oligomers are well known. Examples of such methods are described in U.S. Pat. Nos. 6,369,157 and 6,420,048, WO 03/080705, and U.S. Published Application 2004/0011992, among many others. Any of these conventional polymerization methods are suitable for use with this invention. In general, the polymerization reaction is conducted in a presence of a polymerization catalyst as described below.

The polymerization reaction may be performed in conjunction with some additional melt processing step such as molding or extrusion to produce an article having a predetermined form. The predetermined form of the polymerized article may be, for example, simple pellets or other particulates that can be used in a subsequent melt processing operation. Alternatively, the predetermined form may be some other form of extruded or molded shape which is adapted for some particular application or class of applications. Thus, the predetermined form may have a molded or extruded shape, and may take the form of a fiber-reinforced material.

The polymerization is conducted by heating the oligomer/expanded graphite blend to a temperature above the melting temperature of the macrocyclic oligomer in the presence of the polymerization catalyst. The polymerizing mixture is maintained at the elevated temperature until the desired molecular weight and conversion are obtained. Suitable polymerization temperatures are from about 100° C. to about 300° C., with a temperature range of about 100° C. to about 280° C. being preferable and a temperature range of from 180 to 270° C. being especially preferred. In general, no special polymerization conditions are needed because of the presence of the expanded graphite.

The polymerization catalyst is preferably incorporated into the oligomer/expanded graphite blend at the same time the blend is made, but if not, it can be added during the polymerization or just prior to the polymerization. Enough catalyst is provided to provide a desirable polymerization rate and to obtain the desired conversion of oligomers to polymer, but it is usually desirable to avoid using excessive amounts of a catalyst. A suitable mole ratio of transesterification catalyst to macrocyclic oligomer can range from about 0.01 mole percent or greater, more preferably from about 0.1 mole percent or greater and more preferably 0.2 mole percent or greater. The mole ratio of transesterification catalyst to macrocyclic oligomer is from about 10 mole percent or less, more preferably 2 mole percent or less, even more preferably about 1 mole percent or less and most preferably 0.6 mole percent or less.

The polymerization may be conducted in a closed mold to form a molded article. An advantage of cyclic oligomer polymerization processes is that they allow thermoplastic resin molding operations to be conducted using techniques that are generally applicable to thermosetting resins. When melted, the cyclic oligomer typically has a relatively low viscosity. This allows the cyclic oligomer to be used in reactive molding processes such as liquid resin molding, reaction injection molding and resin transfer molding, as well as in processes such as resin film infusion, impregnation of fiber mats or fabrics, prepreg formation, pultrusion and filament winding that require the resin to penetrate between individual fibers of fiber bundles to form structural composites. Certain processes of these types are described in U.S. Pat. No. 6,420,047, incorporated herein by reference.

The resulting polymer must achieve a temperature below its crystallization temperature before it is demolded. Thus, it may be necessary to cool the polymer before demolding (or otherwise completing processing). In some instances, particularly in polymerizing cyclic butylene terephthalate oligomers, the melting and polymerization temperature of the oligomers are below the crystallization temperature of the resulting polymer. In such a case, the polymerization temperature is advantageously between the melting temperature of the oligomer and the crystallization temperature of the polymer. This allows the polymer to crystallize at the polymerization temperature (isothermal curing) as molecular weight increases. In such cases, it is not necessary to cool the polymer before demolding can occur.

The polymerization can also be conducted as a bulk polymerization to produce a particulate polymer (such as a pelletized polymer) that is useful for subsequent melt processing operations, such as extrusion, injection molding, compression molding, thermoforming, blow molding, resin transfer molding and the like.

It is also possible to conduct a solution polymerization. If the oligomer/expanded graphite blend is made using a solvent for the macrocyclic oligomer, the solvent can serve as the solvent for the solution polymerization, if its boiling temperature is high enough that it is a liquid at the polymerization temperature or if it can be maintained as a liquid at those temperatures using reasonable operating pressures. A solution polymerization is generally performed in bulk, to form a particulate or pelletized polymer that is useful for subsequent melt processing operations as described before. An advantage of the solution polymerization process is that lower temperatures are usually needed to melt the macrocyclic oligomer solution and thus conduct the polymerization. The lower temperatures reduce macrocyclic oligomer degradation and reduce energy requirements. The solution polymerization is suitably conducted at somewhat lower temperatures than a solventless polymerization, and at a temperature below the boiling temperature of the solvent. Suitable solution polymerization temperatures are from 100 to 270° C., especially from 150 to 220° C. Suitable solvents include those described above which have a boiling temperature at or below the polymerization temperature.

If a solution polymerization is performed, the solvent is conveniently removed from the resulting composite. Conventional methods of drying, distillation, vacuum distillation, filtration, extraction or combinations of these can be used. Drying and distillation methods, especially vacuum drying and vacuum distillation methods, are suitable when the diluent has a relatively low boiling temperature. Extraction methods are of particular interest when the solvent is higher-boiling. Extraction methods can be performed on the composite by contacting it with an extractant in which the solvent is miscible. The extractant is generally a volatile hydrocarbon, halocarbon or alcohol having a boiling temperature of below 100° C. The greater volatility of the extractant allows residual quantities of the extractant to be removed from the composite by exposing it to vacuum and/or moderately elevated temperatures. After solvent removal, the composite is suitable for use in various melt-processing procedures to make molded or shaped articles.

A polymerization process of particular interest is a so-called reactive extrusion process, wherein the macrocyclic oligomer is polymerized (in the presence of the expanded graphite particles) in an extrusion device, and the resulting composite is then extruded. This process has the advantage of being readily adapted to continuous operation. The reactive extrusion process permits the oligomer/expanded graphite blend to be formed in situ within the extruder by separately metering in the oligomer and expanded graphite particles. It is more preferred, however, either to form a masterbatch of the oligomer and expanded graphite particles, and let that down by metering additional quantities of the oligomer into the extrusion device, or to use a preformed oligomer/expanded graphite blend at the intended final ratios of those components. Suitable extrusion devices include single- and dual-screw extruders, so-called accumulating extruders and similar devices.

The composite may be further processed to increase its molecular weight. Two approaches to accomplishing this are solid state polymerization and chain extension. Solid state polymerization is achieved by exposing the composite to an elevated temperature. This may be done during melt-processing operations or in a subsequent step. A suitable post-curing temperature is from about 170° C., about 180° C., or about 195° C. up to about 220° C., about 210° C. or about 205° C., but below the melting temperature of the polymer phase of the composite. The solid state polymerization is preferably performed in a non-oxidizing environment such as under a nitrogen or argon atmosphere and is preferably performed under vacuum and/or flowing non-oxidizing gas to remove volatile components. Post-curing time times of from 1 to 36 hours, such as from 4 to 30 hours or from 4 to 24 hours, are generally suitable. Preferably, the macrocyclic oligomer is advanced to a weight average molecular weight of about 60,000 or greater, more preferably about 80,000 or greater and most preferably about 100,000 or greater. It is usually not necessary to use additional catalyst to obtain solid state advancement.

Chain extension is performed by contacting the composite with a polyfunctional chain extending agent. The polyfunctional chain extending agent contains two or more functional groups that react with functional groups on the polymerized macrocyclic oligomer to couple polymer chains and thus increase molecular weight. Suitable such polyfunctional chain extending agents are described below. No additional catalyst is usually required and elevated temperatures as described hereinbefore are used for the chain extension reaction.

When the oligomer/expanded graphite blend is formed as a masterbatch that has a higher concentration of expanded graphite particles than is desired in the final composite, it is necessary to let the masterbatch down into another material before or during the polymerization process. The other material may include an additional quantity of a macrocyclic oligomer (which may be the same or different than that present in the oligomer/graphite blend), one or more other polymerizable materials, and/or a melt-processable polymer, all as described more fully below.

Let-down ratios are selected so that the desired level of the expanded graphite is present in the final product. This level is generally from 1 to 30, especially from 1 to 15%, and more preferably from 2 to 8% expanded graphite by weight. To accomplish this, a let-down weight ratio of from 0.5 to 20 parts of additional polymer or polymerizable material to 1 part masterbatch, especially about 1-10:1, and more preferably about 2-6:1, is often convenient. This can be done by melting the components and mixing them, or by forming a dry blend followed by heating and mixing. Particulate starting materials may be dry blended ahead of time. An advantage of the masterbatch method is that metering of components is simplified, thus helping improve the consistency of the composition of the blended product.

If a masterbatch is formed, it may be polymerized to form a low or high molecular weight polymer dispersion before being let down. This may be beneficial, for example, by increasing the viscosity of the molten masterbatch somewhat so it more closely matches that of another polymeric material, impact modifier or rubber, so that the materials are more easily and efficiently blended together during the let-down process. The masterbatch may be polymerized to form a polymerized macrocyclic oligomer having a weight average molecular weight of, for example, about 2000-20,000, or about 3000-10,000, prior to letting it down. Alternately, the masterbatch may be polymerized to a molecular weight of above 20,000, such as from 30,000-150,000, prior to letting it down.

As mentioned, the polymerization is generally conducted in the presence of a polymerization catalyst. Tin- or titanate-based polymerization catalysts are of particular interest. Examples of such catalysts are described in U.S. Pat. No. 5,498,651 and U.S. Pat. No. 5,547,984, the disclosures of which are incorporated herein by reference. One or more catalysts may be used together or sequentially.

Illustrative examples of classes of tin compounds that may be used in the invention include monoalkyltin hydroxide oxides, monoalkyltinchloride dihydroxides, dialkyltin oxides, bistrialkyltin oxides, monoalkyltin trisalkoxides, dialkyltin dialkoxides, trialkyltin alkoxides, tin compounds having the formula 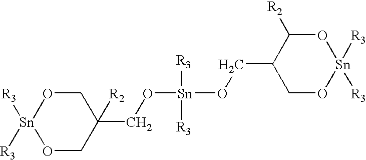
and tin compounds having the formula 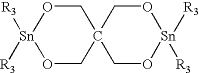
wherein R₂ is a C₁₋₄ primary alkyl group, and R₃ is C₁₋₁₀ alkyl group. Specific examples of organotin compounds that may be used in this invention include 1,1,6,6-tetra-n-butyl-1,6-distanna-2,5,7-10-tetraoxacyclodecane, n-butyltinchloride dihydroxide, di-n-butyltin oxide, di-n-octyltin oxide, n-butyltin tri-n-butoxide, di-n-butyltin di-n-butoxide, 2,2-di-n-butyl-2-stanna-1,3-dioxacycloheptane, and tributyltin ethoxide. In addition, tin catalysts described in U.S. Pat. No. 6,420,047 (incorporated by reference) may be used in the polymerization reaction.

Titanate compounds that may be used in the invention include those described in U.S. Pat. No. 6,420,047 (incorporated by reference). Illustrative examples include tetraalkyl titanates (e.g., tetra(2-ethylhexyl) titanate, tetraisopropyl titanate, and tetrabutyl titanate), isopropyl titanate, titanate tetraalkoxide. Other illustrative examples include (a) titanate compounds having the formula 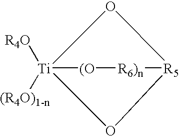
wherein each R₄ is independently an alkyl group, or the two R₄ groups taken together form a divalent aliphatic hydrocarbon group; R₅ is a C₂₋₁₀ divalent or trivalent aliphatic hydrocarbon group; R₆ is a methylene or ethylene group; and n is 0 or 1 (there being no direct bond between the titanium atom and R₅ wherein n is zero), (b) titanate ester compounds having at least one moiety of the formula 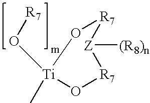
wherein each R₇ is independently a C₂₋₃ alkylene group; Z is O or N; R₈ is a C₁₋₆ alkyl group or unsubstituted or substituted phenyl group; provided when Z is O, m-n-0, and when Z is N, m=0 or 1 and m+n=1, and (c) titanate ester compounds having at least one moiety of the formula 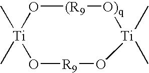
wherein each R₉ is independently a C₂₋₆ alkylene group; and q is 0 or 1.

Other suitable polymerization catalysts can be represented as
RₙQ₍₃₋ₙ₎Sn—O—X (II)
where n is 1 or 2, each R is independently an inertly substituted hydrocarbyl group, Q is an anionic ligand, and X is a moiety having a tin, zinc, aluminum or titanium atom bonded directed to the adjacent oxygen atom. Suitable X groups include —SnRnQ₍₃₋ₙ₎, where R, Q and n are as described before; —ZnQ, where Q is as described before, —Ti(Q)₃, where Q is as described before, and —AlRₚ(Q)₍₂₋ₚ₎, where R is as described before and p is zero, 1 or 2. Preferred Q groups include —OR groups, where R is as described above. When X is SnRₙQ₍₃₋ₙ₎, R and/or OR groups may be divalent radicals that form ring structures including one or more of the tin or other metal atoms in the catalyst. Preferred X moieties are —SnRₙQ₍₃₋ₙ₎, —Ti(OR)₃ and —AlRₚ(OR)₍₂₋ₚ₎. —SnRₙQ₍₃₋ₙ₎ is a particularly preferred type of X moiety. Preferred X groups are —SnRₙQ₍₃₋ₙ₎, —Ti(OR)₃ and —AlRₚ(OR)₍₂₋ₚ₎. n is preferably 2. These catalysts are described in more detail in WO 05/105,899A. Examples of particular polymerization catalysts of this type include 1,3-dichloro-1,1,3,3-tetrabutyldistannoxane; 1,3-dibromo-1,1,3,3-tetrabutyldistannoxane; 1,3-difloro-1,1,3,3-tetrabutyldistannoxane; 1,3-diacetyl-1,1,3,3-tetrabutyldistannoxane; 1-chloro-3-methoxy-1,1,3,3-tetrabutyldistannoxane; 1,3-methoxy-1,1,3,3-tetrabutyl distannoxane; 1,3-ethoxy-1,1,3,3-tetrabutyldistannoxane; 1,3-(1,2-glycolate)-1,1,3,3-tetrabutyldistannoxane; 1,3-dichloro-1,1,3,3-tetraphenyldistannoxane; (n-butyl)₂(ethoxy)Sn—O—Al(ethoxide)₂, (n-butyl)₂(methoxy)Sn—O—Zn(methoxide), (n-butyl)₂(i-propoxy)Sn—O—Ti(i-propoxide)₃, (n-butyl)₃Sn—O—Al(ethyl)₂, (t-butyl)₂(ethoxy)Sn—O—Al(ethoxide)₂, and the like. Suitable distannoxane catalysts are described in U.S. Pat. No. 6,350,850, incorporated herein by reference.

The polymerization may be conducted in the presence of a polyfunctional chain extending compound having two or more functional groups which will react with functional groups on the polymerized macrocyclic oligomer (and/or another polymer in the blend). Examples of suitable functional groups are epoxy, isocyanate, ester, hydroxyl, carboxylic acid, carboxylic acid anhydride or carboxylic acid halide groups. More preferably, the functional groups are isocyanate or epoxy, with epoxy functional groups being most preferred. Preferred epoxy-containing chain extenders are aliphatic or aromatic glycidyl ethers. Preferred isocyanate-containing chain extenders include both aromatic and aliphatic diisocyanates. Preferably, the chain extender has about 2 to about 4, more preferably about 2 to about 3 and most preferably about 2 such functional groups per molecule, on average. The chain extender material suitably has an equivalent weight per functional group of 500 or less. A suitable amount of chain extender provides, for example, at least 0.25 mole of functional groups per mole of reactive groups in the polymerized macrocyclic oligomer. These materials may be incorporated into the oligomer/expanded graphite blend prior to polymerization, or added to the blend immediately prior to or during the polymerization process.

Similarly, the polymerization may be conducted in the presence of another polymerizable material. Suitable other polymerizable materials include a monomer other than a macrocyclic oligomer that can form random or block copolymers with the macrocyclic oligomer, or other polymerizable material. Suitable copolymerizable monomers include cyclic esters such as lactones. The lactone conveniently contains a 4-7 member ring containing one or more ester linkages. The lactone may be substituted or unsubstituted. Suitable substituent groups include halogen, alkyl, aryl, alkoxyl, cyano, ether, sulfide or tertiary amine groups. Substituent groups preferably are not reactive with an ester group in such a way that they cause the copolymerizable monomer to function as an initiator compound. Examples of such copolymerizable monomers include glycolide, dioxanone, 1,4-dioxane-2,3-dione, ε-caprolactone, tetramethyl glycolide, β-butyrolactone, lactide, γ-butyrolactone and pivalolactone.

A melt-processable polymer also may be present during the polymerization of the oligomer/expanded graphite blend. The melt-processable polymer may be incorporated into the oligomer/expanded graphite blend, or added to it separately prior to or during the polymerization. Such a melt-processable polymer may be, for example, a polymer of the macrocyclic oligomer or another macrocyclic oligomer, a polymer that is compatible with the polymerized macrocyclic oligomer, a polymer that is reactive with the macrocyclic oligomer or its polymer (such as one that forms a random or block copolymer therewith, or contains functional groups that react with the macrocyclic oligomer or its polymer), or even a polymer that is relatively incompatible with the macrocyclic oligomer or its polymer (to form a phase-segregated blend or alloy). Examples of suitable polymers include, for example, polyesters such as poly(ε-caprolactam), polybutylene terephthalate, polyethylene adipate, polyethylene terephthalate and the like, polyamides, polycarbonates, polyurethanes, polyether polyols, polyester polyols, and amine-functional polyethers and/polyesters. Polyolefins (such as polymers and interpolymers of ethylene, propylene, a butylene isomer and/or other polymerizable alkenes) that contain functional groups that react with functional groups on the polymerized macrocyclic oligomer and/or a chain extending agent can be used. Other polymeric materials that are compatible with the macrocyclic oligomer and/or the polymerized macrocyclic oligomer or contain functional groups that permit them to be coupled to the polymerized macrocyclic oligomer are also useful. Certain of these polymers may engage in transesterification reactions with the macrocyclic oligomer or its polymer during the polymerization process, to form block copolymers. Polymeric materials having reactive functional groups may be coupled to the polymerized macrocyclic oligomer with chain extenders as described above. Suitable functionalized polymeric materials contain about 1 or more, more preferably about 2 to about 3 and most preferably about 2 such functional groups per molecule, on average, and have an equivalent weight per functional group of greater than 500. Their number average molecular weights are suitably up to about 100,000, such as up to about 20,000 or up to about 10,000. Preferably, the polymeric material has a glass transition temperature significantly lower (such at least 10° C. lower or at least 30° C. lower) than the glass transition temperature of the polymerized macrocyclic oligomer alone. The lower glass transition temperature polymeric materials tend to improve the ductility and impact resistance of the resulting product. The functionalized polymer can contain any backbone which achieves the desired results of this invention. An especially suitable polyfunctional polymer is a polyether or polyester polyol.

Another optional component during the polymerization of the oligomer/expanded graphite blend is an impact modifier. Any impact modifier which improves the impact properties and toughness of the polymer composition may be used. Examples of impact modifiers include core-shell modifiers, olefinic toughening agents, block copolymers of monovinylidene aromatic compounds and alkadienes and ethylene-propylene diene monomer based polymers. The impact modifiers can be unfunctionalized or functionalized with polar functional groups. Suitable core-shell rubbers include functionalized core-shell rubbers having surface functional groups that react with the macrocyclic oligomer or functional groups on the polymerized macrocyclic oligomers. Preferred functional groups are glycidyl ether moieties or glycidyl acrylate moieties. The core-shell rubber will generally contain about 30 to about 90 percent by weight core, where “core” refers to the central, elastomeric portion of the core-shell rubber. The core-shell modifier may be added after the polymerization is complete, in a high shear environment such as an extruder.

A natural or synthetic rubber is another type of modifier that is useful and may be present during the polymerization. Rubber is generally added to improve the toughness of the polymer. Rubber-modified polymers desirably exhibit a dart impact strength (according to ASTM D3763-99) of about 50 inch/lbs (5.65 N-m) or greater, more preferably about 150 inch/lbs (16.95 N-m) or greater and most preferably about 300 inch/lbs (33.9 N-m) or greater.

When one or more of these optional materials (catalyst, chain extender, additional polymer, impact modifier or rubber) is present in the oligomer/expanded graphite blend, the macrocyclic oligomer preferably constitutes from about 25 to 95% of the weight of the blend, for example from 40 to 85% or from 50 to 80% of the weight of the blend.

In addition to the previously-described chain extenders and modifiers, various kinds of optional materials may be incorporated into the polymerization process. Examples of such materials include other particulate fillers reinforcing agents (such as glass, carbon black or other fibers), flame retardants, colorants, antioxidants, preservatives, mold release agents, lubricants, UV stabilizers, and the like.

The composite of the invention generally has a significantly lower volume resistivity than that of the polymer matrix alone, due to the presence of the expanded graphite particles. A preferred composite of the invention has a volume resistivity, measured according to ASTM D-4496, of no greater than 1.0×10⁸ ohm-cm. When the expanded graphite is the only conductive filler or additive present in the composite, a volume resistivity of 1.0×10⁸ ohm-cm or lower is typically achieved when the composite contains from about 2% or more, preferably up to about 8%, by weight of the expanded graphite.

A more preferred composite has a volume resistivity of no greater than 1.0×10⁶ ohm-cm. An even more preferred composite has a volume resistivity of no greater than 1.0×10⁵ ohm-cm. An especially preferred composite has a volume resistivity of no greater than 1.0×10⁴ ohm-cm. In most applications, it is not necessary that the composite have a volume resistivity of less than 1.0×10² ohm-cm. A most preferred composite exhibits a volume resistivity within these ranges with an expanded graphite content of from about 3 to about 6% by weight. It is within the scope of the invention to incorporate additional conductive fillers or other conductive materials into the composite, such as carbon nanotubes, metal flakes or fibers, and the like. In most cases, however, sufficient electroconductivity can be imparted to the composite through the incorporation of the expanded graphite alone.

The expanded graphite particles also modify the physical and thermal properties of the composite. Of particular interest are properties such as heat sag and heat distortion temperature under load. For many applications the composite should exhibit a heat sag, as measured according to ASTM D3769, of no greater than 6 mm, preferably no greater than 4 mm, after heating at 200° C. for 30 minutes. An especially preferred composite exhibits a heat sag of less than 3 mm under those conditions. These heat sag values usually can be achieved with this invention when the expanded graphite constitutes 2% or more of the weight of the composite, such as from 2 to 8% of the composite weight.

The composite preferably exhibits a heat distortion temperature under load of at least 140° C., preferably at least 160° C. and more preferably at least 170° C., as measured according to ASTM D648. The composite for many applications suitably exhibits a tensile modulus of at least 2 GPa, preferably at least 3 GPa and more preferably at least 3.5 GPa. The composite for many applications suitably exhibits a coefficient of linear thermal expansion (CLTE), as measured according to ASTM D696, of no greater than 150×10⁻⁶ cm/cm/° C., more preferably no greater than 100×10⁻⁶ cm/cm/° C. and especially no greater than 80×10⁻⁶ cm/cm/° C. These heat distortion and CLTE values usually can be achieved with this invention when the expanded graphite constitutes 2% or more of the weight of the composite, such as from 2-8% of the composite weight.

For many applications, the composite suitably exhibits a storage modulus (G) measured according to ASTM D5279-01 of at least 90 MPa throughout the temperature range of 20-200° C. These storage modulus values usually can be achieved with this invention when the expanded graphite constitutes 2% or more of the weight of the composite, such as from 2-8% of the composite weight.

The following examples are provided to illustrate the invention, but are not intended to limit the scope thereof. All parts and percentages are by weight unless otherwise indicated.

### EXAMPLE 1

50 grams of cyclic butylene terephthalate oligomer (CBTO) and 2 grams of GRAFTech® GPB expanded graphite worms are dried in a vacuum at 100° C. for 2 hours. The expanded graphite worms have a BET surface area of 34 m²/g.

The dried CBTO is melted in a thermostatically controlled melting pot at 170° C. The expanded graphite worms are added and mixed into the oligomer with a rotor stator. The mixture is cooled, powdered and allowed to dry overnight at 100° C. to form an oligomer/expanded graphite blend containing about 3.8% by weight of the expanded graphite.

50 grams of the powdered blend are added to a HAAKE blender at 250° C. and held at that temperature for two minutes to allow the oligomer to melt. At that point, 0.160 g of butyltin chloride dihydroxide catalyst (0.3 mol %) is sprinkled into the blender and the oligomer is allowed to polymerize to polybutylene terephthalate (PBT) for 10 minutes. The resulting composite is then removed, grounded into granules and placed in a vacuum oven for 12 hours at 195° C. to advance the molecular weight of the polymer. The composite is then remelted at 250° C. in a melt index machine to obtain a strand for volume resistivity measurement. The volume resistivity measures 5.70×10³ ohm-cm. The composite contains 3.8% by weight of the expanded graphite particles.

### EXAMPLE 2

47.5 grams of cyclic butylene terephthalate oligomer (CBTO) and 2.5 grams of GRAFTech GPB expanded graphite worms are added to 300 ml of distilled water in a beaker and stirred on a hot plate 2 hours at 170° C. The water remaining after the heating step is removed by heating in a vacuum oven at 100° C. overnight. The resulting oligomer/expanded graphite blend (containing 5% by weight expanded graphite) is polymerized in the manner described in Example 1 to obtain a composite exhibiting a volume resistivity of 2.63×10³ ohm-cm.

### EXAMPLE 3

47.5 grams of cyclic butylene terephthalate oligomer (CBTO) and 2.5 grams of GRAFTech® GPB expanded graphite worms are dried in a vacuum at 100° C. for 2 hours. The dried materials are then added to approximately 100 ml of chloroform in a flask and sonicated in an ultrasonic bath at 100 watt power for 4 hours. The solvent is then removed by blowing it off with nitrogen gas and dried in a vacuum oven overnight at 40° C. The resulting oligomer/expanded graphite blend (containing 5% by weight expanded graphite) is polymerized in the manner described in Example 1 to obtain a composite exhibiting a volume resistivity of 2.34×10³ ohm-cm.

### EXAMPLE 4

47.5 grams of cyclic butylene terephthalate oligomer (CBTO) and 2.5 grams of GRAFTech GPB expanded graphite worms are dried in a vacuum at 100° C. for 2 hrs. The dried materials are then added to approximately 100 ml of chloroform in a beaker and sonicated using a sonication horn at 400 watts power for 20 minutes. The solvent is then removed by rotoevaporation and the remaining product dried in a vacuum oven overnight at 100° C. The resulting oligomer/expanded graphite blend (containing 5% by weight expanded graphite) is polymerized in the manner described in Example 1 to obtain a composite exhibiting a volume resistivity of 2.10×10³ ohm-cm.

### EXAMPLE 5

Example 4 is repeated, except that 48 grams of cyclic butylene terephthalate oligomer and 2 grams of the expanded graphite worms are used, to form a composite containing 4% by weight of the expanded graphite. The volume resistivity of the resulting composite is 2.20×10⁴ ohm-cm.

### EXAMPLE 6

Example 4 is again repeated, except that the expanded graphite in this example is expanded graphite formed from HP Materials Solution 50 expandable graphite material. This product has a BET surface area of 39.6 m²/g. WAXS studies of the expanded graphite produce shows a low intensity peak at about 3.363±0.2 d-spacing. This peak has an intensity of less than 10% of that exhibited by graphite material prior to expansion. The volume resistivity of the resulting composite is 2.50×10² ohm-cm. It contains 5% by weight of the expanded graphite.

### EXAMPLE 7

Example 6 is repeated, except that 48 grams of cyclic butylene terephthalate oligomer and 2 grams of the expanded graphite worms are used, to produce a composite containing 4% of the expanded graphite by weight. The volume resistivity of the resulting composite is 2.50×10⁴ ohm-cm.

### EXAMPLE 8

Example 7 is repeated, except that 48.5 grams of cyclic butylene terephthalate oligomer and 1.5 grams of the expanded graphite worms are used to produce a composite containing 3% by weight of the expanded graphite. The volume resistivity of the resulting composite is 1.28×10⁵ ohm-cm.

### EXAMPLE 9

50 g of an acid-intercalated graphite (GRAFGuard 160-50N) is added to a 3-necked flask. 255 ml of concentrated sulfuric acid is added, followed by 135 ml of concentrated nitric acid. The mixture is chilled to 0-5° C. with stirring. 137.5 g of potassium chlorate is added in small portions, maintaining the temperature below 10° C. Following the addition of the potassium chlorate, the temperature of the mixture is raised to about 22° C. and held at that temperature for about 100 hours. This mixture congeals into a black foamy sludge during that time. Gas is vented from the flask, and 300 ml concentrated sulfuric acid is added with stirring for 30 minutes. The mixture is then added to 14 L of deionized water, and stirred for five minutes. The intercalated (and oxidized) graphite settles out of the aqueous phase and is removed by filtration. The filter cake is washed with two-1000 ml portions of 5% HCl and four-1000 ml portions of deionized water. The filtercake is then broken into ˜1 cm pieces and dried for two days at 60° C. The dried material is then chopped, sieved through a 10 mesh screen, and dried overnight under vacuum at 60° C. to produce a dry, granular material.

The dried material is expanded under nitrogen in a 975° C. electric tube oven for about 3 minutes. The resulting expanded graphite material is cooled in the oven to 75° C. and removed. The material is then chopped in a Waring blender at high speed for about 10 seconds.

This expanded graphite material has a BET surface area of over 700 m²/g. On WAXS, this material shows almost the complete absence of a peak at 3.36±0.02 d-spacing.

A composite is made using this expanded graphite material in the same manner as described in Example 8. The resulting composite contains 3% by weight expanded graphite particles and has a volume resistivity of 2.65×10³ ohm-cm.

A second composite is made on a larger scale, using an oligomer/expanded graphite blend made from 480 grams of the CBTO and 20 grams of the expanded graphite (4% by weight expanded graphite). The volume resistivity measures 2.28×10² ohm-cm when tested on a melt index strand and 6.53×10³ ohm-cm when tested on an injection molded bar.

### EXAMPLES 10 AND 11

An expanded graphite having a surface area of about 702 m²/g is made using the general method described in Example 9. A powdered cyclic butylene terephthalate macrocyclic oligomer is dry blended with this material and 0.34% by weight distannoxane (0.3 moles/mole of macrocyclic oligomer) to provide a mixture containing 4% by weight expanded graphite. The mixture is starve-fed using a screw-type powder feeder into a reactive extrusion (REX) process to produce a composite. The REX process equipment consists of a co-rotating twin screw extruder (Werner Pfleiderer and Krupp, 25 mm, 38 L/D) equipped with a gear pump, a 1″ (2.5 cm) static mixer (Kenics), a 2.5″ (6.25 cm) filter (80/325/80 mesh) and a two hole die downstream. The feeder and hopper are padded with inert gas during operation. The extruder is operated at 200-300 rpm, 15 lb/hr (6.8 kg/hr), and the temperature profile is increased from 50° C. in the initial section to 250° C. over the latter sections of the extruder and downstream process equipment. This provides sufficient mixing in the initial sections for dispersing the filler and sufficient residence time in the latter sections to complete the polymerization. Pellets produced in this manner are then subjected to solid state polymerization (SSP) in a vacuum oven at 200° C. for 26 hours. The resulting composite is Example 10. A transmission electron micrograph of the composite appears in the FIGURE.

Test bars are molded from the composite Example 10 using a 28 ton Arburg injection molding machine. Molding conditions are barrel temperature—260° C.; nozzle temperature—270° C.; mold temperature—82° C.; fill time—˜1.3 seconds; cooling time—30 seconds.

Composite Example 11 is made in a similar manner, except it contains 5% by weight of an expanded graphite having a surface area of about 40 m²/g, as described in Example 6. Test bars are prepared as described for composite Example 10.

For comparison, test bars are molded from an unfilled polymer of the macrocyclic oligomer.

The tensile modulus and electrical conductivities of the test bars are measured. Results are as reported in Table 1.

TABLE 1

| | | Expanded | | |
|---|---|---|---|---|
| | Wt-% | Graphite | Tensile | Volume |
| | Expanded | Surface Area, | Modulus, psi | Resistivity, |
| Example No. | Graphite | m²/g | (10⁵ Pa) | ohm cm |
| 10 | 4 | 702 | 4.99 | 6.55 × 10³ |
| 11 | 5 | 40 | 4.66 | 6.47 × 10⁷ |
| Unfilled | 0 | N/A | 3.7 | >1 × 10¹² |

It will be appreciated that many modifications can be made to the invention as described herein without departing from the spirit of the invention, the scope of which is defined by the appended claims.

What is claimed is:

1. A composite comprising a matrix of a polymer of a macrocyclic oligomer, the polymer matrix having dispersed therein at least about 1% by weight of expanded graphite particles, based on the weight of the composite.

2. The composite of claim 1 wherein the expanded graphite has a BET surface area of at least 15 m²/g.

3. The composite of claim 2 wherein the expanded graphite has a BET surface area of at least 120 m²/g.

4. The composite of claim 1 which has a volume resistivity of no greater than 1×10⁸ ohm-cm.

5. The composite of claim 4 which contains from about 2 to about 8% by weight of the expanded graphite.

6. The composite of claim 1 wherein the macrocyclic oligomer includes cyclic butylene terephthalate.

7. The composite of claim 6 which has a volume resistivity of no greater than 1×10⁸ ohm-cm.

8. The composite of claim 7 which contains from about 2 to about 8% by weight of the expanded graphite.

9. The composite of claim 1 which has a heat distortion temperature under load of no greater than 170° C., measured according to ASTM D648.

10. The composite of claim 9 which exhibits a heat sag of no greater than 3 mm, when measured according to ASTM D3769 after heating for 30 minutes at 200° C.

11. The composite of claim 10 which exhibits a coefficient of linear thermal expansion of no greater than 80×10⁻⁶ cm/cm/° C.

12. The composite of claim 11 which exhibits a storage modulus (G′) of at least 90 mPA throughout the temperature range of 20-200° C.

13. The composite of claim 1 further comprising at least one additional polymer, at least one impact modifier or at least one rubber, or a mixture of two or more thereof.

14. The composite of claim 1 wherein the polymer of the macrocyclic oligomer is a copolymer of the macrocyclic oligomer and at least one comonomer that is not a macrocyclic oligomer.

15. The composite of claim 4 wherein the expanded graphite particles have a surface area of at least 500 m²/g.

16. The composite of claim 1 which has a volume resistivity of 1×10² to 1×10⁶ ohm-cm and the expanded graphite has a BET surface area of at least 400 m²/g.

17. The composite of claim 1 wherein the composite has a volume resistivity of 1×10² to 1×10⁴ ohm-cm, the composite contains from 2-5% by weight of the expanded graphite and the expanded graphite has a BET surface area of at least 650 m²/g.

18. The composite of claim 1 wherein the expanded graphite has a BET surface area of at least 650 m²/g.

19. A dispersion of expanded graphite particles in a macrocyclic oligomer, the dispersion containing at least about 1 percent by weight of the expanded graphite particles.

20. The dispersion of claim 19 wherein the expanded graphite has a BET surface area of at least 15 m²/g.

21. The dispersion of claim 20 wherein the expanded graphite has a BET surface area of at least 120 m²/g.

22. The dispersion of claim 21 wherein the expanded graphite has a BET surface area of at least 400 m²/g.

23. The dispersion of claim 22 wherein the expanded graphite has a BET surface area of at least 650 m²/g.

24. The dispersion of claim 19 which contains from about 2 to about 8% by weight of the expanded graphite.

25. The dispersion of claim 19 wherein the macrocyclic oligomer includes cyclic butylene terephthalate.

26. The dispersion of claim 19 further comprising at least one additional polymer, at least one impact modifier or at least one rubber, or a mixture of two or more thereof.

27. The dispersion of claim 19 further comprising at least one comonomer other than a macrocyclic oligomer.

28. A polymerization process comprising subjecting a dispersion of expanded graphite particles in a macrocyclic oligomer to conditions sufficient to polymerize the macrocyclic oligomer to form a composite comprising a matrix of a polymer of a macrocyclic oligomer, the polymer matrix having dispersed therein at least about 1% by weight of expanded graphite particles.

29. The polymerization process of claim 28 wherein the expanded graphite has a BET surface area of at least 15 m²/g.

30. The process of claim 29 wherein the expanded graphite has a BET surface area of at least 120 m²/g.

31. The process of claim 30 wherein the expanded graphite has a BET surface area of at least 400 m²/g.

32. The process of claim 31 wherein the expanded graphite has a BET surface area of at least 650 m²/g.

33. The polymerization process of claim 28 wherein the macrocyclic oligomer includes cyclic butylene terephthalate.

34. The polymerization process of claim 28 wherein the dispersion contains from about 2 to about 8% by weight of the expanded graphite.

35. The polymerization process of claim 28 which is conducted in the presence of a solvent.

36. The polymerization process of claim 35, further comprising removing the solvent from the composite.

37. The polymerization process of claim 36, further comprising conducting a solid state polymerization step on the composite.

38. The polymerization process of claim 28, which is conducted in a closed mold.

39. The polymerization process of claim 38, which is performed at a temperature below the crystallization temperature of the polymerized macrocyclic oligomer.

40. The polymerization process of claim 28, which is a reactive extrusion process.

41. A polymerization process comprising
a) polymerizing a dispersion of expanded graphite particles in a macrocyclic oligomer to form a filled polymer of the macrocyclic oligomer, the polymer having dispersed therein at least about 1% by weight of expanded graphite particles;
b) cooling the formed filled polymer to below the softening temperature of the filled polymer and then
c) advancing the molecular weight of the polymer of the macrocyclic oligomer by heating the formed composite to an elevated temperature below the softening temperature of the filled polymer.
